(19) United States
(12) Patent Application Publication
(10) Pub. No.: US 2013/0308950 A1
(43) Pub. Date: Nov. 21, 2013

(54) OPTICAL PASS-BAND FILTERING METHOD AND DEVICE AND A DEVICE FOR INSERTING/EXTRACTING A FREQUENCY MULTIPLEXED OPTICAL SUB-BAND INTO/FROM AN OPTICAL SIGNAL

(71) Applicants: Sofiene Blouza, Le Kram (TN); Julie Karaki, Mont Liban (LB); Erwan Pincemin, Gommenec'h (FR)

(72) Inventors: Sofiene Blouza, Le Kram (TN); Julie Karaki, Mont Liban (LB); Erwan Pincemin, Gommenec'h (FR)

(73) Assignee: ORANGE, Paris (FR)

(21) Appl. No.: 13/983,630

(22) PCT Filed: Feb. 7, 2012
(86) PCT No.: PCT/FR2012/050260

§ 371 Date: Aug. 5, 2013

(30) Foreign Application Priority Data
Feb. 10, 2011 (FR) 1151082

(51) Int. Cl. H04J 14/02

(52) U.S. Cl. CPC H04J 14/02
USPC 398/79

(57) ABSTRACT

An optical pass-band filtering device comprises a duplicator able to provide duplicates of an optical signal to at least a first and a second output port; a first optical filtering unit connected to the first output port of the duplicator, said unit having a transfer function that decreases between a first pass wavelength and a first cut-off wavelength; a second optical filtering unit, connected to the second output port of the duplicator, said unit having a transfer function that increases between a second cut-off pass wavelength, the second cut-off wavelength being higher than the first; and coupler connected to the first and second optical filtering units that combine the optical signals filtered by said optical filtering units to obtain a filtered optical signal in which the optical band located between the first and second cut-off wavelengths is removed. A related device node using is also provided.

The invention relates to the field of devices for inserting/extracting optical signals in optical transmission networks.

To cope with the increasing speed of optical transmission systems, the limits of wavelength division multiplexing (WDM) technology have continually been stretched.

In order to attain a speed of 100 Gbit/s per wavelength over long distances, or even to go beyond this threshold, it is possible to multiplex components at 10 Gbit/s (using 10 GbEthernet technology) so as to obtain an ultra-high-speed channel of 100 Gbit/s (using 100 GbEthernet technology).

The need to easily aggregate or disaggregate these components into a WDM channel during transmission becomes essential in order to provide for a high degree of flexibility in the ultra-high-speed optical transport networks. Such disaggregation is only of interest, both in terms of cost and power consumption, if it is all-optical.

First of all, modulation formats that can be used at 100 Gbit/s are based on a single-carrier modulation technique (coherent QPSK) not suitable for intra-channel optical switching.

It is also possible to use multiplexing in orthogonal frequencies (OFDM=Orthogonal Frequency Division Multiplexing). This type of multiplexing is a multi-carrier modulation technique that can be implemented using one or several sub-bands carrying the WDM channel traffic and is a very serious candidate for extending the capacity of the optical channel to 100 Gbps, 400 Gbps and 1 Tbps in the near or more distant future.

In fact, OFDM multiplexing inherently provides robustness against the effects of dispersion, whether chromatic or PMD polarization mode dispersion. Added to these advantages in terms of transmission is the flexibility that multi-band OFDM (MB-OFDM) technology brings in intra-channel optical switching, or more generally in networking.

Thus, due to its multi-band approach, OFDM multiplexing is the ideal candidate to implement intra-channel optical switching to easily disaggregate or aggregate the independent OFDM sub-bands, even inside a WDM channel.

In order to take advantage of the flexibility offered by this type of MB-OFDM technology, “band-pass” and “pass-band” filters are required to select or remove the sub-bands in transit in a node.

Currently, optical “band-pass” filters having a square flat-top type transfer function and widths at mid-height of about 50 pm are possible. However, the currently available optical “pass-band” filters are not very selective, hardly tunable at the central wavelength, and limited in the profile of their transfer function as well as in terms of spectral width. There is no guarantee that such filters can be developed in the near future using current technologies, such as wavelength selective switches (WSS).

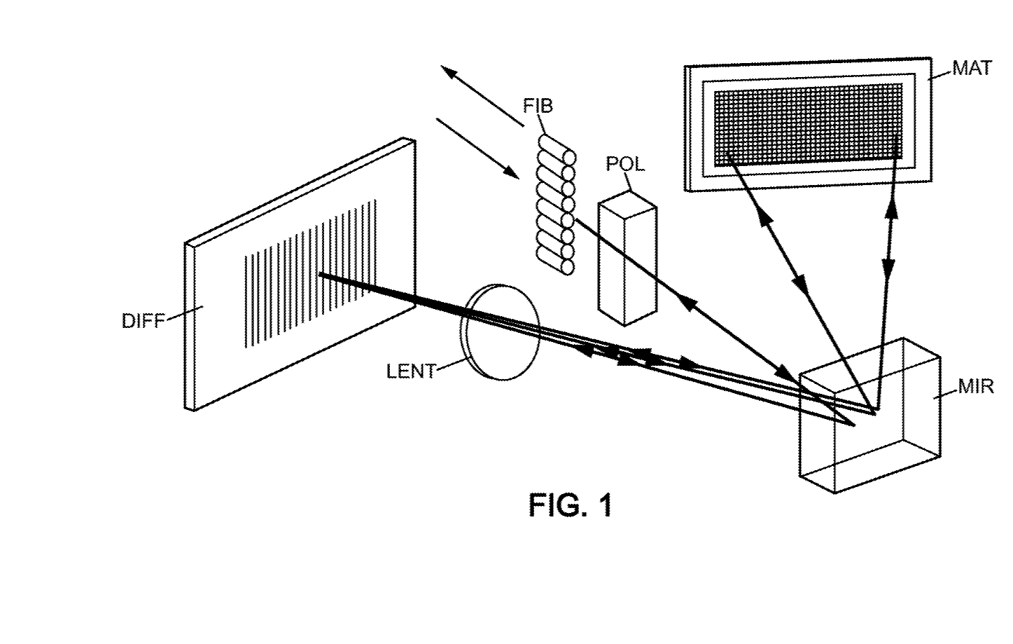

FIG. 1 illustrates such a wavelength selective switch.

An optical signal enters such a switch through an input fiber from the fiber network FIB, passes through an optical polarization-diversity component, then is reflected on a cylindrical mirror MIR, before passing through a lens LENT and being diffracted by a grating DIFF, reflected a second time by the cylindrical mirror MIR and processed with a liquid crystal matrix MAT (LCoS=Liquid Crystal on Silicon).

This liquid crystal matrix serves, on the one hand, to switch the optical signal so that it exits through another output fiber from the fiber network FIB and, on the other hand, to attenuate the optical signal.

A WSS switch has the particular characteristic of being able to send any wavelength arriving on the input fiber to any of the N output fibers, and to attenuate these different wavelengths selectively so as to compensate, for example, for the non-flat response of a sequence of optical amplifiers.

A conventionally-sized WSS switch (about 15 cm per side) typically has a transfer function with a minimum spectral width of 50 GHz. If a more selective (narrower) transfer function is desired, either the size of each cell of the liquid crystal matrix will have to be smaller, or the liquid crystal matrix will have to be moved away from the diffraction grating so that the different spectral components of the input signal can be further dispersed spatially.

The size of such a WSS switch is therefore roughly inversely proportional to the filtered spectral width, which increases the size of the WSS switch to the point of making it unusable in practice when it is necessary to obtain filtering spectral widths less than 50 GHz.

The size of the components being a critical criterion for telecommunications network carriers (companies), WSS switches are not suitable for finer pass-band filtering, and are thus limited in terms of wavelength selectivity. Thus, currently, the most powerful optical “pass-band” filter boasts a width at mid-height (i.e., at −3 dB) between 200 and 250 pm (i.e., between 25 and 31.25 GHz) and its profile is nearer to a Gaussian than to the rectangular profile of a door.

These characteristics make this type of filter unusable for manipulating optical bands that require a heightened selectivity, such as, for example, when wanting to remove, in a MB-OFDM channel, one or several sub-bands whose width can vary, for example, from 50 pm to 400 pm (i.e., from 6.25 to 50 GHz) to perform an add/drop function.

Therefore, there currently exists a need to supply, in the field of optical transmission, an optical pass-band filter with better selectivity than the filters currently available, as well as greater tunability both in terms of spectral width and central wavelength, suitable for use in finer filtering applications than what is required in current WDM technologies, such as, for example, what is required for filtering orthogonal frequency-multiplexed optical sub-bands.

An objective of the present invention is to propose an optical pass-band filtering device which can offer better selectivity, a pass-band that is adjustable to narrower bands and with a central frequency of removed bands that is more easily tunable, all while maintaining acceptable optical component dimensions.

Another objective of the present invention is to propose an insertion/extraction device to extract and replace a frequency-multiplexed optical sub-band in an optical signal.

Another objective of the present invention is to propose an insertion/extraction node to extract or replace a frequency-multiplexed optical sub-band in an optical channel which itself is wavelength-multiplexed in an optical signal.

For this purpose, the present invention proposes an optical pass-band filtering device comprising duplication means suitable for duplicating an optical signal on at least a first and a second output port; a first optical filtering unit connected to the first output port of the duplication means and having a transfer function which decreases between a first pass wavelength and a first cut-off wavelength; a second optical filtering unit connected to the second output port of the duplication means and having a transfer function which increases between a second cut-off wavelength and a second pass wavelength, the second cut-off wavelength being higher than the first cut-off wavelength; and coupling means, connected to the first and second optical filtering units and arranged so as to combine optical signals filtered by said optical filtering units in order to obtain a filtered optical signal in which the optical band located between the first and second cut-off wavelengths is removed.

In an advantageous embodiment of the invention, the first and second filtering units comprise an optical band-pass filter having an essentially rectangular profile in which the cut-off frequency between the first pass wavelength and the first cut-off wavelength, and between the second pass wavelength and the second cut-off wavelength, is at least 30 dB. The use of optical band-pass filters in the device of this invention allows obtaining better selectivity overall.

Advantageously, the spectral difference between the first and second cut-off wavelength is less than or equal to 10 GHz, which allows for the more accurate removal of a specific optical sub-band in an optical signal consisting of a plurality of multiplexed optical sub-bands with a low spectral range, as is the case with an MB-OFDM signal.

Advantageously, the spectral difference between the first pass wavelength and the first cut-off wavelength and/or the spectral difference between the second pass wavelength and the second cut-off wavelength is less than or equal to 5 GHz, which allows removing an optical sub-band without impacting the neighboring optical sub-band within an optical signal comprising a plurality of multiplexed optical sub-bands with a low spectral range, as is the case with an MB-OFDM signal.

According to another embodiment, the duplication means are further suitable for duplicating the optical signal on a third output port, the transfer function of the second optical filtering unit also decreases between a third pass wavelength, higher than the second pass wavelength, and a third cut-off wavelength, and the device comprises a third optical filtering unit, connected to the third output port of the duplication means, having a transfer function which increases between a fourth cut-off wavelength and a fourth pass wavelength, the fourth cut-off wavelength being higher than the third cut-off wavelength, and the coupling means are further connected to the third filtering unit and arranged so as to combine the optical signals filtered by said optical filtering units in order to obtain a filtered optical signal in which the optical band located between the third and fourth cut-off wavelengths is also removed.

This other embodiment allows the filtering of several non-contiguous optical sub-bands within an optical signal comprising a plurality of frequency-multiplexed optical sub-bands.

This invention proposes also the use of the aforementioned optical pass-band filtering device to filter at least one optical sub-band of an optical signal that comprises a plurality of frequency-multiplexed optical sub-bands.

The present invention further proposes an insertion/extraction optical device comprising duplication means suitable for duplicating an optical signal into a first duplicated optical signal and a second duplicated optical signal; an optical band-pass filtering unit arranged to extract a first optical sub-band from the first duplicated optical signal so as to output said first optical sub-band from the device; the aforementioned optical pass-band filtering device arranged to remove a second optical sub-band in the second duplicated optical signal; and coupling means suitable for coupling the optical signal filtered by the optical pass-band filtering device with an optical signal comprising a replacement optical sub-band located in the spectral range defined by the second optical sub-band, so as to output a modified optical signal in which the second optical sub-band is replaced by the replacement optical sub-band.

The present invention also proposes an optical node for the insertion/extraction of at least a first optical sub-band belonging to a first optical channel contained in an optical signal comprising a plurality of wavelength-multiplexed optical channels. This optical node comprises duplication means suitable for duplicating the optical signal into a first duplicated optical signal and a second duplicated optical signal; extraction means comprising a first wavelength-demultiplexing means arranged to extract at least the first optical channel from the first duplicated optical signal and at least one optical band-pass filtering means arranged to extract the first optical sub-band from the first extracted optical channel, so as to output an optical signal comprising the sub-first optical band; a second wavelength-demultiplexing means arranged to extract at least the first optical channel from the second duplicated optical signal; a first optical pass-band filtering device as described above, arranged to remove the first optical sub-band from the first extracted optical channel so as to obtain a first filtered optical channel; and first coupling means suitable for coupling the first filtered optical channel with an optical signal comprising a first replacement optical sub-band so as to output a first modified optical channel in which the first optical sub-band is replaced by the first replacement optical sub-band.

According to an embodiment of this node, the second wavelength-demultiplexing means is further arranged to extract from the second duplicated optical signal a second optical channel comprising a second optical sub-band, and the node comprises: a second optical pass-band filtering device as described above, arranged to remove the second optical sub-band from the second extracted optical channel so as to obtain a second filtered optical channel; second coupling means suitable for coupling the second filtered optical channel with an optical signal comprising a second replacement optical sub-band so as to output a second modified optical channel in which the second optical sub-band is replaced by the second replacement optical sub-band; and wavelength-multiplexing means arranged to multiplex at least the first and second modified optical channels so as to obtain a modified optical signal in which the first and second sub-bands have been respectively replaced by the first and second replacement optical sub-bands.

This invention also proposes a method for the optical pass-band filtering of at least a first optical band in an optical signal, this method comprising:

the duplication of the optical signal into at least two duplicated optical signals;

the filtering of the first duplicated optical signal by means of a first optical band-pass filtering unit having a transfer function which decreases between a first pass wavelength and a first cut-off wavelength;

the filtering of the second duplicated optical signal by means of a second optical band-pass filtering unit having a transfer function which increases between a second cut-off wavelength and a second pass wavelength; and

the combining of the two filtered optical signals to obtain a filtered optical signal in which the optical band between the first and second cut-off wavelengths is removed.

According to an embodiment, the optical signal is duplicated into three duplicated optical signals during the duplication step; the transfer function of the second optical pass-band filtering unit also decreases between a third pass wavelength, higher than the second pass wavelength, and a third cut-off wavelength; the method further comprises the filtering of the third duplicated optical signal by means of a third optical band-pass filtering unit having a transfer function which increases between a fourth cut-off wavelength and a fourth pass wavelength; and the three filtered optical signals are combined during the combination step so as to obtain a filtered optical signal in which the optical band between the third and fourth cut-off wavelengths is also removed.

This invention proposes also a method for replacing at least a first optical sub-band in an optical signal, this method comprising:

the removal of the first optical sub-band from the optical signal by means of the aforementioned optical pass-band filtering method so as to obtain a filtered signal; and

the addition of a replacement optical sub-band located spectrally in the first optical sub-band to the filtered optical signal so as to obtain a modified optical signal in which the first optical sub-band is replaced by the replacement optical sub-band.

The present invention further proposes a method for the extraction and replacement of at least a first optical sub-band in an optical signal, the method comprising:

the duplication of the optical signal in at least two duplicated optical signals;

the extraction of the first optical sub-band from the first duplicated optical signal by means of band-pass filtering;

the replacement of the first optical sub-band by a replacement optical sub-band in the second duplicated optical signal by means of the aforementioned replacement method.

The present invention proposes also a method for replacing at least a first optical sub-band in a first optical channel of an optical signal composed of a plurality of wavelength-multiplexed optical channels, the method comprising:

the extraction of the first optical channel from the optical signal;

the removal of the first optical sub-band from the optical signal by means of the aforementioned optical pass-band filtering method so as to obtain a first filtered channel; and

the addition of a first replacement optical sub-band located spectrally in the first optical sub-band to the first filtered channel so as to obtain a modified optical channel in which the first optical sub-band is replaced by the first replacement optical sub-band.

The present invention also proposes a method for the extraction and replacement of at least a first optical sub-band in a first optical channel of an optical signal composed of a plurality of wavelength-multiplexed optical channels, this method comprising:

the duplication of the optical signal into at least two duplicated optical signals;

the extraction of the first optical sub-band from the first duplicated optical signal by means of demultiplexing means and band-pass filtering means; and

the replacement of the first optical sub-band by a replacement optical sub-band in the first optical channel of the second duplicated optical signal by means of the aforementioned replacement method.

Other features and advantages of the invention will become apparent upon review of the following detailed description and the attached drawings, aside from the previously described FIG. 1:

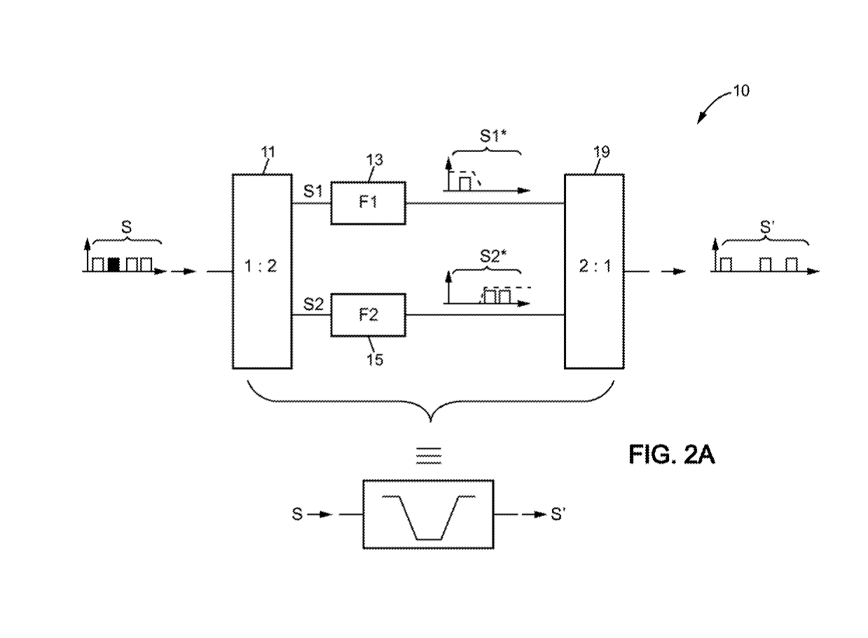

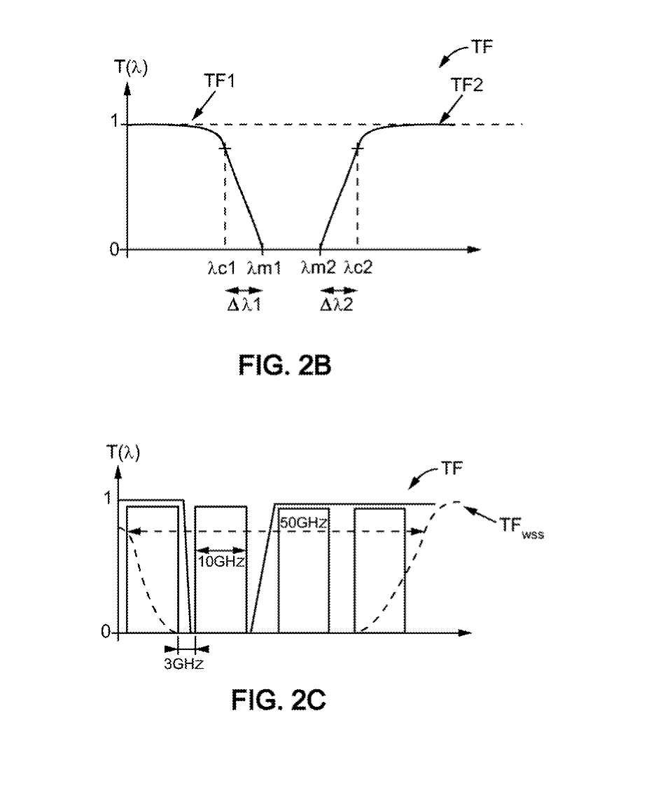

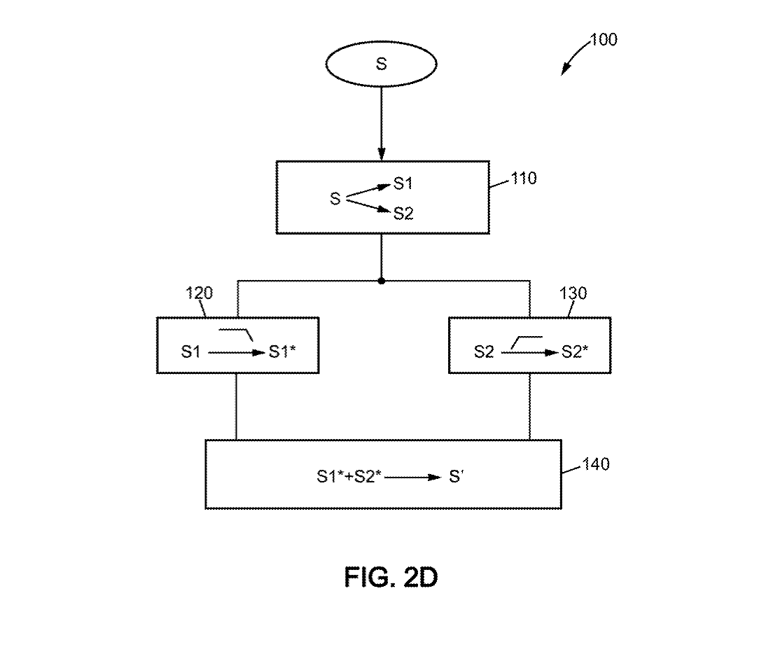

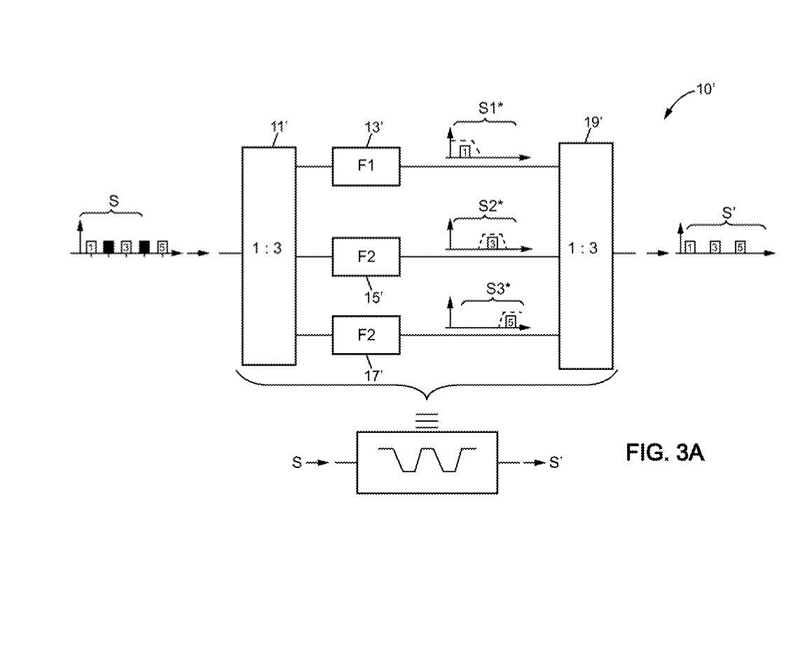

FIG. 2A represents an optical pass-band filtering device according to the present invention;

FIG. 2B illustrates in detail the overall transfer function of the optical pass-band filtering device according to the present invention;

FIG. 2C illustrates an optical signal comprising four (4) frequency-multiplexed optical sub-bands superimposed on the respective transfer functions of a WSS optical pass-band filter and an optical pass-band filtering device according to the present invention;

FIG. 2D illustrates the stages of an optical pass-band filtering method according to the present invention;

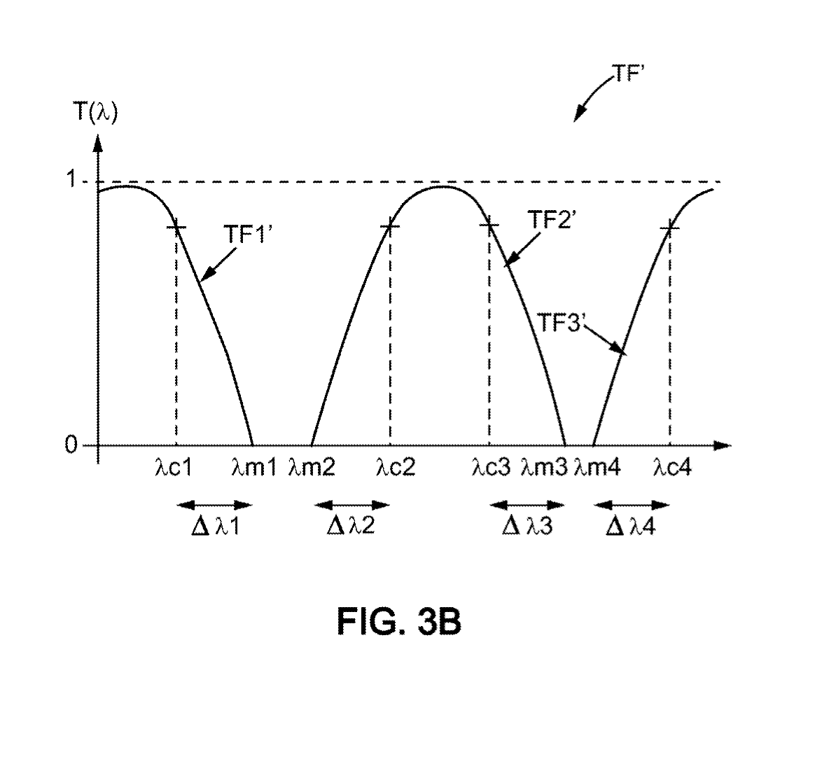

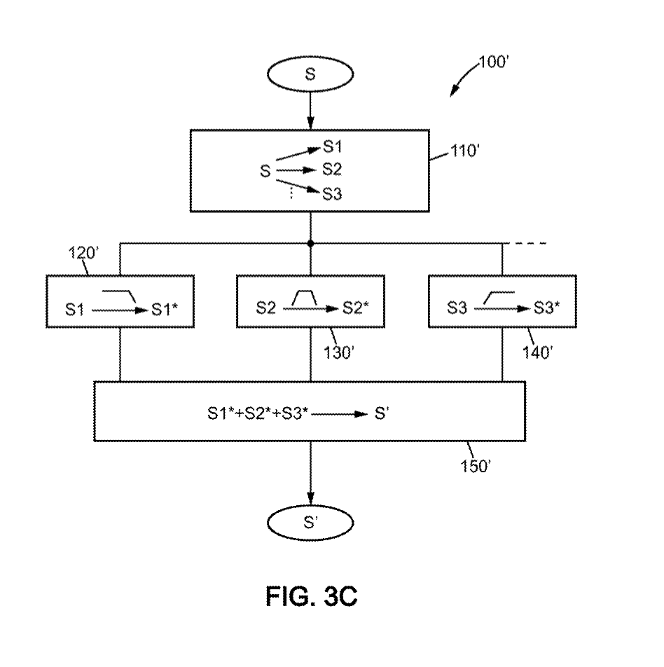

FIG. 3A schematically represents a first embodiment of the optical pass-band filtering device according to the present invention, which aims to remove two optical sub-bands;

FIG. 3B illustrates in detail the overall transfer function of the optical pass-band filtering device according to the above first embodiment;

FIG. 3C illustrates the steps of an optical pass-band filtering method according to the first embodiment of the present invention;

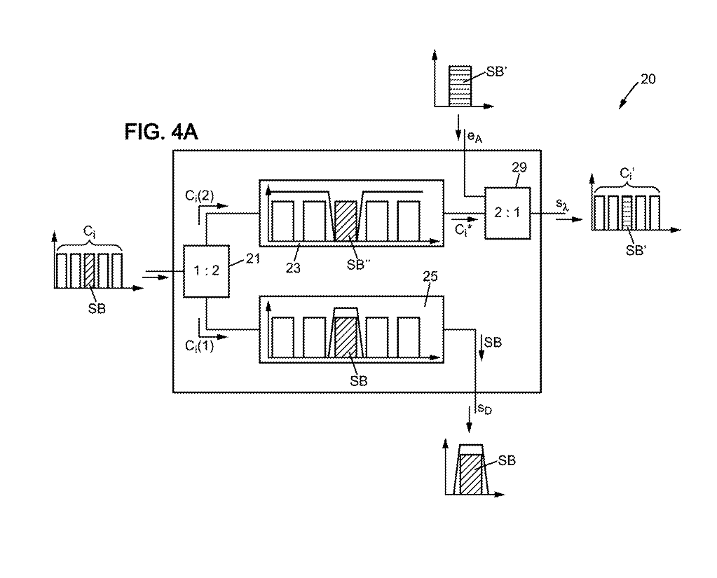

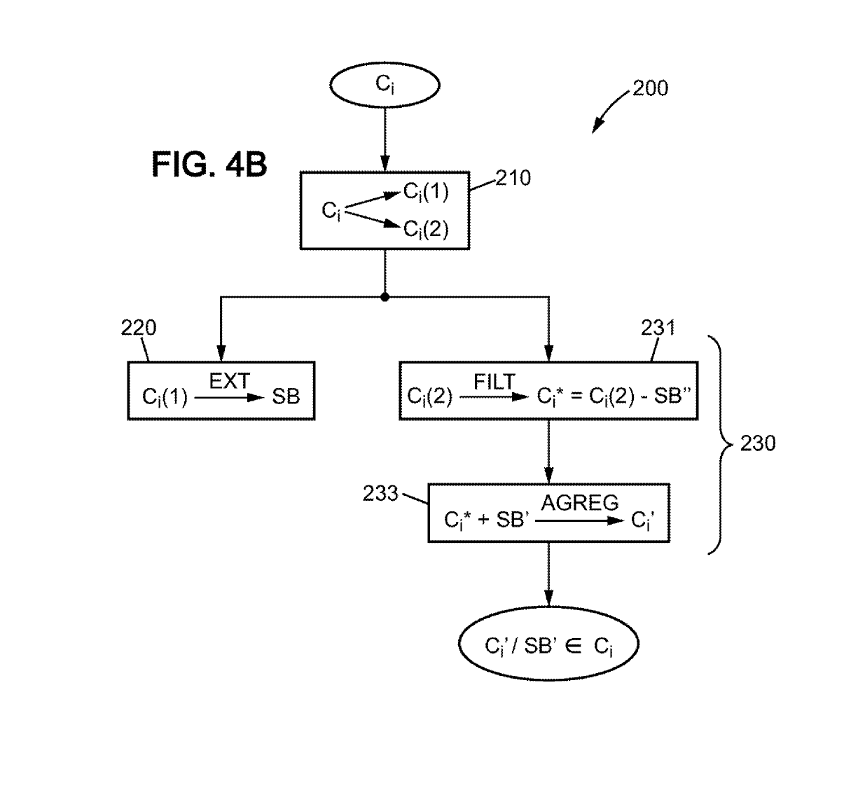

FIG. 4A schematically represents a device for inserting/extracting an optical sub-band in an optical signal according to the present invention;

FIG. 4B illustrates the steps of a method for extracting and replacing an optical sub-band in an optical signal according to the present invention;

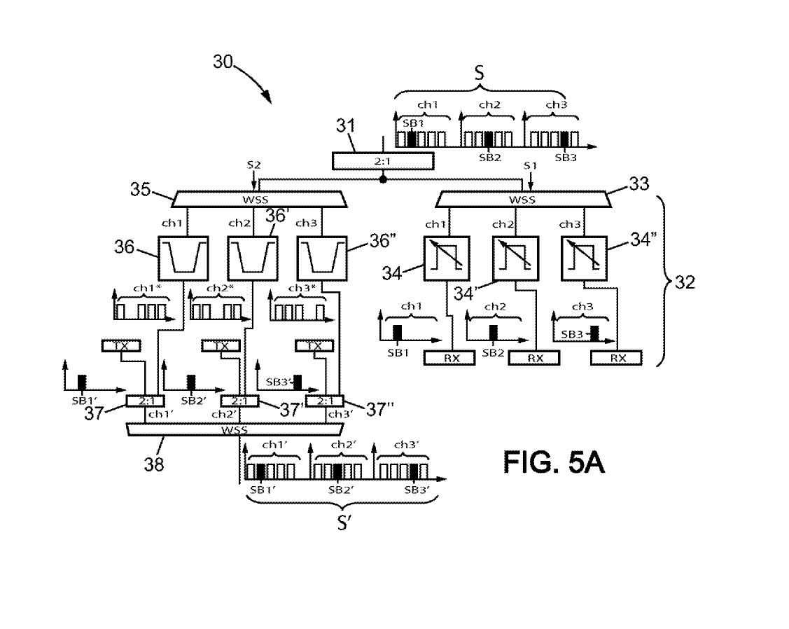

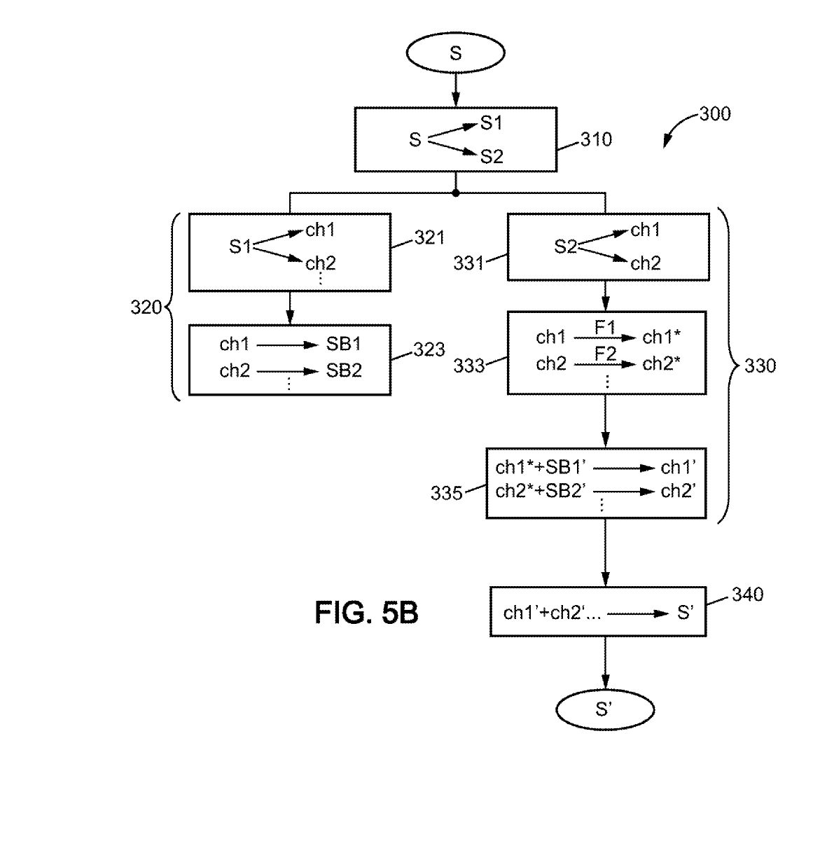

FIG. 5A schematically represents a node for inserting/extracting an optical sub-band within an optical channel of an optical signal according to the present invention; and

FIG. 5B illustrates the steps of a method for extracting and replacing an optical sub-band within an optical channel of an optical signal according to the present invention.

First FIG. 2A is referred to, which illustrates an optical pass-band filtering device 10 according to the present invention.

This device comprises, on the one hand, duplication means 11 suitable for duplicating an optical signal S, received on an input port, into at least two duplicated signals S1 and S2 provided at the respective output ports.

This duplication operation can be carried out, for example, by dividing the received optical signal S into as many identical optical signals as the duplication means 11 have output ports. In the case of a division of strength, the strength of the duplicated signals is reduced in relation to the original signal S. The distribution of the optical strength of the input optical signal S between the two duplicated signals S1 and S2 is advantageously about 50/50, or can be within a distribution range of 50/50 to 45/55 so as to obtain two duplicated signals with overall similar strengths. The duplication means 11 can thus consist of a 1:2 coupling, even a 55/45 coupling.

The optical pass-band filtering device 10 also comprises at least a first optical filtering unit 13, connected to the first output port of the duplication means 11 so as to receive the duplicated signal S1, as well as a second optical filtering unit 15, connected to the second output port of the duplication means 11 so as to receive the duplicated signal S2.

The first optical filtering unit 13 has a transfer function TF1(λ), which decreases between a first pass wavelength λc1, for which the transfer function TF1(λ) takes a value of 10 dB below the maximum value of this transfer function, and a first cut-off wavelength λm1 for which this transfer function takes a value of substantially zero, for example of 40 dB below the maximum value of the transfer function. This parameter, referred to as the “edge slope” of the filter, is expressed in dB/nm.

Inversely, the second optical filtering unit 15 has a transfer function TF2(λ) which increases between a second cut-off wavelength λm2, for which this transfer function TF2(λ) takes a value of substantially zero (for example of 40 dB below the maximum value of the transfer function), and a second pass wavelength λc2, for which the transfer function TF2(λ) takes a value of 10 dB below the maximum value of this transfer function.

In particular, the first and second filtering units 13 and 15 can comprise an optical pass-band filter having an essentially rectangular profile in which the cut-off frequency between the first pass wavelength λc1 and the first cut-off wavelength λm1, and between the second pass wavelength λc2 and the second cut-off wavelength λm2, is at least 30 dB.

The optical pass-band filtering device also comprises coupling means 19 connected to the output ports of the first and second optical filtering units 13 and 15 by two respective input ports. These means 19 are arranged so as to combine the optical signals respectively filtered by these optical filtering units so as to obtain a filtered optical signal S′, in which the optical band located between the first and second cut-off wavelengths λm1 et λm2 is removed, this filtered optical signal S′ thus being output at the output port of the coupling means, which corresponds to the output port of the optical pass-band filtering device 10. Such coupling means 19 can consist of a 2:1 coupling, even a 55/45 coupling.

To illustrate the invention, the signal S is represented as being an optical signal consisting of four (4) frequency-multiplexed optical sub-bands. The term “optical sub-band” here is understood to mean an optical signal situated in a predetermined frequency band and able to be multiplexed with other similar “optical sub-bands” to form a multiplexed signal, for example frequency-multiplexed by OFDM technology.

Here, one is seeking to remove in particular the second sub-band from the signal S. The first filtering unit 13 lets the first sub-band of this signal pass, while the second filtering unit 15 lets the third and fourth sub-bands of this signal pass. The signal S′, the result of combining the outputs of these two filtering units, is therefore a signal in which the second sub-band was removed and the device 10 as a whole is equivalent to an optical pass-band filter.

To understand the invention better, we will now refer to FIG. 2B which illustrates in more detail the overall transfer function TF(λ) of the optical pass-band filtering device 10, as well as the respective transfer functions TF1(λ) and TF2(λ) of the filtering units 13 and 15.

In particular, the transfer function TF1(λ) decreases between the first pass wavelength λc1, where its value is substantially 10 dB below its maximum, and the first cut-off wavelength λm1, which corresponds substantially to the wavelength for which the transfer function TF1(λ) attains a substantially zero value (for example 40 dB below the maximum value of the transfer function). Beyond this cut-off wavelength λm1, the value of the transfer function remains substantially at zero at least until the second cut-off wavelength λm2 of the transfer function TF2(λ).

Such a transfer function TF1(λ), which can be seen as corresponding at least partially to an optical high-pass filter, can be obtained with an optical band-pass filter, for example with an essentially rectangular profile also referred to as a square flat-top, if one were to consider only the decreasing part of this transfer function.

For its part, the transfer function TF2(λ) increases between the second cut-off wavelength λm2, beyond which the value of the transfer function TF2(λ) remains substantially zero at least until the first cut-off wavelength λm1, and the second pass wavelength λc2 where the value of this transfer function TF2(λ) attains a threshold substantially 10 dB below its maximum.

Similarly, such a transfer function TF2(λ), which can be viewed as corresponding at least partially to an optical low-pass filter, can be obtained with an optical band-pass filter, for example with an essentially rectangular profile, if one were to consider only the increasing part of this transfer function.

Thus, the overall transfer function TF of the optical filtering device described in FIG. 1 corresponds to the superposition of the transfer functions TF1(λ) and TF2(λ), in which the optical band located between the cut-off wavelengths λm1 and λm2 is removed, in other words blocked, while the wavelengths lower than the first pass wavelength λc1 or higher than the second pass wavelength λc2 pass through this device.

This overall transfer function TF has therefore a form associated with an optical pass-band filtering removing the optical band between λm1 and λm2.

The selective character of such an optical pass-band filtering device is linked to the ability of its transfer function TF to pass rapidly, in terms of wavelength, from a value near its maximum (corresponding to transmission of the optical signal) to a value near zero (corresponding to blocking the optical signal).

This selective character can be characterized, on the one hand, by the difference Δλ1 between wavelengths λc1 and λm1, and on the other hand, by the difference Δλ2 between wavelengths λm2 and λc2. In this way, the smaller this difference Δλ1, the greater the slope of the decreasing part of the transfer function TF, and the more selective the device is on the left of the optical band that has been removed. Reciprocally, the lower the difference Δλ2, the greater the slope of the increasing part of the transfer function TF, and the more selective the device is on the right of the optical band that has been removed.

It is also possible to use the concept of “edge slope” to characterize the selective character of a filter, this edge slope corresponding to the ratio (in absolute value) between, on the one hand, the difference in strength (in dB) between the value taken by the transfer function TF for the pass wavelength and the value taken by the function TF for the corresponding cut-off wavelength and, on the other hand, the spectral difference between these two wavelengths.

In other words, the edge slope PF₁ in the decreasing part of the function TF described in FIG. 2B is defined according to the following equation:

$${PF}_{1} = \vert \frac{TF 1 ( λ c 1 ) - TF 1 ( λ m 1 )}{Δ λ 1} \vert$$

And the edge slope PF₂ in the increasing part of the function TF is defined according to the following equation:

$${PF}_{2} = \vert \frac{TF 2 ( λ m 2 ) - TF 2 ( λ c 2 )}{Δ λ 2} \vert$$

It is well understood that the greater the values of these edge slopes, the more selective the optical pass-band filter according to the invention is.

As indicated above concerning the optical filtering components currently available, the rare optical pass-band filters available, such as for example the Wavelength Selective Switch type filters described above or Wavelength Blocker type filters based on the concatenation of a diffraction grating and a MEMS mirror array or a liquid crystal matrix, have a low spectral selectivity, typically about 400 pm or 50 GHz, insufficient to block an optical sub-band while allowing the neighboring optical sub-band to pass through in a multiplex of frequency-multiplexed sub-bands where the gap between sub-bands is typically about 5 GHz (i.e., 40 pm).

Moreover, in terms of spectral width, the current Wavelength Selective Switch or Wavelength Blocker optical filters have a stop-band which is more on the order of 50 GHz (i.e., 400 pm), which makes such filters unusable for blocking a specific optical sub-band, particularly when it is an optical sub-band in a multiplex of frequency-multiplexed sub-bands where the width is typically about 10 GHz (i.e., 50 pm). With such multiplexes, the current Wavelength Selective Switch or Wavelength Blocker optical filters cannot block less than four (4) optical sub-bands at a time.

As indicated above, to attain such selectivity or spectral width levels with such optical filters, the proportions of the liquid crystal matrix must be expanded such that it poses a size problem and therefore cannot be integrated into an optical node of a network.

By contrast, among the optical filtering components currently available, there exist optical band-pass filters having a true essentially rectangular profile, such as the filters that use “Free Space Optics” technology which associates a diffraction grating with a monochromator (in other words, a slit that will select a predetermined area of the diffracted spectrum).

These optical band-pass filters have a wider selectivity, with differences between the pass wavelength and cut-off wavelength that are less than or equal to 5 GHz (i.e. 40 pm), which blocks an optical sub-band while allowing the passage of the neighboring optical sub-band in a multiplex of frequency-multiplexed sub-bands spaced at 5 GHz.

With such optical band-pass filters, high edge slopes can be attained, greater than or equal to 750 dB/nm, for example about 800 dB/nm, which represents a difference in transmission strength of the filter of 40 dB over 50 pm (or 6.25 GHz).

Therefore the present invention uses the fact that available optical band-pass filters offer better selectivity than the available optical pass-band filters, for constructing an optical pass-band filter from such optical band-pass filters so as to obtain increased selectivity.

In addition to its selective character, FIG. 1B also shows that the filtering device of the present invention obtains stop-band bandwidths and stopband central frequencies that are more adjustable than with conventional optical pass-band filters.

In fact, in the filtering device of the present invention, the individual adjustment of the cut-off frequencies λc1 and λc2 of the first and second filtering units regulate, on the one hand, the width of the optical band removed as well as, on the other hand, the central frequency of this band, which corresponds substantially to the median value between these two cut-off frequencies.

Being able to act on the two filtering units, for example using control means connected to these two units to regulate these two parameters, allows for a finer adjustment of these two parameters than what is possible with conventional optical pass-band filters, particularly if the filtering units 13 and 15 are optical band-pass filters in free space (“Free Space Optics”) associating a diffraction grating with a monochromator in which the cut-off frequency can be tuned with great precision.

A pass-band filtering with filter edge slopes of about 800 dB/nm can be achieved, which is impossible to achieve today with the Wavelength Selective Switch or Wavelength Blocker optical pass-band filters. Removing such a wide band is particularly advantageous in the field of optical frequency multiplexing, where the optical sub-bands can have widths of this size. A specific optical sub-band can thus be removed without impacting the neighboring optical sub-bands.

These various advantages are illustrated in more detail in FIG. 2C, which illustrates an optical signal comprising four (4) frequency-multiplexed optical sub-bands, as indicated in FIG. 2A, superimposed on the transfer functions TF_{wss} of an optical pass-band filter WSS and TF of an optical pass-band filtering device according to the present invention, in normal form.

As an example, these optical sub-bands have a width of 10 GHz and are spaced apart by 5 GHz.

One can clearly see that the transfer function TF allows removing the second optical sub-band without touching the other optical sub-bands, due to its greater potential selectivity, which cannot be done with the typical transfer function TF_{wss} of Wavelength Selective Switch or Wavelength Blocker optical pass-band filters having a “flat top” type profile with a stop-band width of about 400 pm or 50 GHz, better suited for filtering an entire channel rather than for filtering a typical 10 GHz OFDM sub-band.

We will now refer to FIG. 2D where the steps of a method 100 for optical pass-band filtering of a first optical band in an optical signal are illustrated, which can be carried out by means of the device 10 described above.

This method 100 comprises a first step 110 of duplication of the optical signal S in at least two duplicated optical signals 51 and S2.

This method 100 next comprises, on the one hand, the filtering 120 of the first duplicated optical signal 51 by means of a first optical band-pass filtering unit 13 having a transfer function TF1 which decreases between a first pass wavelength λc1 and a first cut-off wavelength λm1, so as to obtain a first filtered signal S1*.

In parallel, this method 100 comprises the filtering 130 of the second duplicated optical signal S2 by means of a second optical band-pass filtering unit 15 having a transfer function TF2 which increases between a second cut-off wavelength λm2 and a second pass wavelength λc2 so as to obtain a second filtered signal S2*.

Once the two filtered signals S1* and S2* are obtained, the method 100 comprises a step 140 of combining these two filtered optical signals so as to obtain a modified optical signal S′ in which the optical band located between the first and second cut-off wavelengths λm1 and λm2 is removed.

The principle of the invention is not limited to the construction of an optical pass-band filtering device removing a single optical band, but can be extended to the removal of a plurality of optical sub-bands, as illustrated below in FIG. 3A.

This FIG. 3A schematically represents an embodiment of the optical pass-band filtering device according to the present invention, which aims to remove two optical sub-bands so as to illustrate the removal of a plurality of sub-bands in a simple case.

This device 10′ comprises, on the one hand, duplication means 11′ suitable for duplicating an optical signal S, received on an input port, into three duplicated signals S1, S2, S3 respectively output on three output ports. These means 11′ can take the form, for example, of an optical 1:3 coupling.

This device 11′ is respectively connected to three optical filtering units 13′, 15′ and 17′ by its three output ports.

The first optical filtering unit 13′ is similar to the first optical filtering unit 13, and thus has a transfer function TF1(λ) which decreases between a first pass wavelength λc1 and a first cut-off wavelength λm1.

The second optical filtering unit 15′ has a transfer function TF2(λ) which increases between a second cut-off wavelength λm2 and a second pass wavelength λc2, similarly to the second optical filtering unit 15. However, this transfer function TF2(λ) further decreases between a third pass wavelength λc3, higher than the second pass wavelength λc2, and a third cut-off wavelength λm3 for which said transfer function TF2(λ) takes a value that is substantially zero.

In other words, the second optical filtering unit 15′ can realized in the form of an optical band-pass filter which allows to pass through an optical band that is located substantially between the pass wavelengths λc2 and λc3.

As for the third optical filtering unit 17′, it has a transfer function TF3(λ) which increases between a fourth cut-off wavelength λm4, for which this transfer function TF3(λ) takes a value that is substantially zero and higher than the third cut-off wavelength λm3, and a fourth pass wavelength λc4. In this sense this third filtering unit 17′ is similar to the optical filtering unit 15 illustrated in FIG. 2A.

These three optical filtering units have outputs respectively coupled to the three inputs of the coupling means 19′, which are then arranged so as to combine the optical signals filtered by these three optical filtering units so as to obtain a filtered optical signal S′ from which a first optical band located between the first and second cut-off wavelengths λm1, λm2 as well as a second optical band located between the third and fourth cut-off wavelengths λm3, λm4 are removed. This signal S′ is then output from the coupling means 19′, which corresponds to the output of the device 10′.

Thus, by applying an optical signal S comprising five frequency-multiplexed optical sub-bands as illustrated in FIG. 3A, this device 10′ is capable of outputting an optical signal S′ comprising only the first, third and fifth optical sub-bands, i.e. where the second and fourth optical sub-bands (shaded in FIG. 3A) have been removed.

FIG. 3B illustrates in more detail the overall transfer function TF′ corresponding to filtering device 10′.

In particular, the respective transfer functions TF1′(λ) and TF3′(λ) of the optical filtering units 13′ and 17′ are similar to the transfer functions TF1(λ) and TF2(λ) of the optical filtering units 13 and 15 already discussed in relation to FIG. 2B.

Transfer function TF2′ (λ) is added to these transfer functions. It increases between the second cut-off wavelength λm2 and the second pass wavelength λc2 as well as decreases between the third pass wavelength λc3 and the third cut-off wavelength λm3.

The overall transfer function TF′ results from the superimposition of the three transfer functions TF1′, TF2′ and TF3′ and allows removing the optical sub-bands of a signal which falls within the optical bands located, on the one hand, between the cut-off wavelengths λm1 and λm2 and, on the other hand, between the cut-off wavelengths λm3 and λm4.

This overall transfer function is particularly advantageous as it allows for the selective and refined removal of narrow, non-neighboring optical bands in a multiplex of optical sub-bands, which is impossible with conventional optical pass-band filters.

From the embodiment described in FIGS. 3A and 3B, it can be seen that the present invention can concern more generally an optical pass-band filtering device capable of removing n optical bands (with n>1), this device thus comprising duplication means of coupling type 1:n+1 having n+1 output ports respectively connected to the inputs of n−1 optical filtering units similar to unit 15′, as well as an optical filtering unit similar to unit 13′ and an optical filtering unit similar to unit 17′, the outputs of all of these n+1 optical filtering units being connected to the n+1 inputs of coupling means of coupling type n+1:1, so as to couple the n+1 filtered signals to obtain a signal in which n optical bands are removed.

We will now refer to FIG. 3C which illustrates the steps of a method 100′ for optical pass-band filtering of first and second optical bands in an optical signal, which can be carried out by means of the device 10′ described above.

This method 100′ comprises of a first step 110′ of duplicating the optical signal S into three duplicated optical signals S1, S2 and S3.

This method 100′ then comprises, on the one hand, the filtering 120′ of the first duplicated optical signal S1 by means of a first optical band-pass filtering unit 13′ having a transfer function TF1 which decreases between a first pass wavelength λc1 and a first cut-off wavelength λm1, so as to obtain a first filtered signal S1*.

In parallel, this method 100′ comprises the filtering 130′ of the second duplicated optical signal S2 by means of a second optical band-pass filtering unit 15′ having a transfer function TF2 which, on the one hand, increases between a second cut-off wavelength λm2 and a second pass wavelength λc2 and which, on the other hand, decreases between a third pass wavelength λc3, higher than the second pass wavelength λc2, and a third cut-off wavelength λm3, so as to obtain a second filtered signal S2*.

In parallel, this method 100′ comprises the filtering 140′ of the third duplicated optical signal S3 by means of a third optical band-pass filtering unit 17′ having a transfer function TF3 which increases between a fourth cut-off wavelength λm4 and a fourth pass wavelength λc4, so as to obtain a third filtered signal S3*.

Once the three filtered signals S1*, S2* and S3* have been obtained, these three filtered optical signals are combined during the combination step (150′), so as to obtain a modified optical signal S′ in which the two optical bands located respectively between the first and second cut-off wavelengths and the third and fourth cut-off wavelengths are removed.

We will now refer to FIG. 4A, which illustrates an insertion/extraction device using the optical pass-band filtering device 10 according to the present invention.

Such an insertion/extraction device aims, on the one hand, to extract a first specific optical sub-band SB from within an optical signal corresponding to an optical channel Cᵢ comprising a certain number of frequency-multiplexed optical sub-bands, and on the other hand, to insert a replacement optical sub-band SB′ by replacing a second optical sub-band SB″ so as to obtain a modified optical channel Cᵢ′. These two operations can be carried out simultaneously, and this device can be advantageously used within an optical node of an optical transmission network in order to extract and/or add data to the optical signals.

The term “optical channel” is understood here to mean an optical signal located substantially at a predetermined wavelength and capable of being wavelength-multiplexed with other similar optical channels to form a wavelength-multiplexed signal.

Thus, in the context of the present invention, the optical channel Cᵢ under consideration consists of a plurality of multiplexed optical sub-bands (the quantity of five appearing in FIG. 4A is purely for illustrative purposes, as it is obvious that this optical channel can be composed of any number of optical sub-bands), for example frequency-multiplexed using OFDM technology.

Among these optical sub-bands is therefore the first optical sub-band SB intended to be extracted as well as the second optical sub-band SB″ intended to be replaced by the replacement optical sub-band SB′ located substantially in the same band of frequencies, these first and second optical sub-bands SB and SB″ possibly substantially coincident in the frequency domain or even forming a single optical sub-band SB intended to be both extracted and replaced by a replacement sub-band SB′.

The insertion/extraction device 20 comprises duplication means 21 suitable for duplicating the optical signal Cᵢ in a first duplicated optical signal Cᵢ(1) output from a first output port, and a second duplicated optical signal Cᵢ(2) output from a second output port. For example, these duplication means can consist of a 1:2 coupling.

The insertion/extraction device 20 further comprises an optical pass-band filtering unit 25, connected to the first output port of the duplication means 21, and arranged to extract the first optical sub-band from the first duplicated optical signal Cᵢ(1) so as to output said first optical sub-band SB from an output port s_{D} of the device 20. Advantageously, this optical band-pass filtering unit has a transfer function with an essentially rectangular profile so as to optimize selectivity in terms of sub-band extraction.

The insertion/extraction device 20 moreover comprises an optical pass-band filtering device 23 similar to the previously described device 10, connected to the second output port of the duplication means 21, and arranged to remove the second optical sub-band SB″ in the second duplicated optical signal Cᵢ(2) so as to obtain a filtered optical signal Cᵢ* in which this optical sub-band SB″ no longer exists.

In the particular case where the first optical sub-band SB and the second optical sub-band SB″ coincide spectrally, the filtered optical channel Cᵢ* output from the pass-band filtering device 23 is thus complementary to the filtered optical signal output from the filtering unit 25, and the addition of these two filtered signals corresponds to the input optical signal Cᵢ.

The insertion/extraction device 20 also comprises coupling means 29, of which one of the input ports is connected to the output of the optical pass-band filtering device 23 so as to receive the filtered optical signal Cᵢ*. These coupling means are suitable for coupling this filtered optical signal Cᵢ* with an optical signal e_{A} comprising a replacement optical sub-band SB′, advantageously located in the spectral range defined by the second optical sub-band SB″, so as to output a modified optical signal Cᵢ′ on an output port s_{λ}, in which the second optical sub-band SB″ is replaced by the replacement optical sub-band SB′. Such coupling means 19 can be implemented as a 1:2 coupling, even a 55/45 coupling.

To illustrate simply the principle of the invention, the insertion/extraction device 20 of FIG. 4A is of degree 2, i.e. it allows only one replacement sub-band to be inserted at a time. It is, however, entirely conceivable to construct an insertion/extraction device 20 of degree n, where n>2, in which case the duplication means 21 must comprise n duplication ports to which pass-band filtering units similar to device 23 are connected. Each filtered optical signal from one of these pass-band filtering means can therefore permit the insertion of one replacement sub-band via a coupling means similar to coupling means 29.

Similarly, FIG. 4A illustrates the case where a single optical sub-band SB″ is replaced. It is, however, entirely possible to replace a number n′ of optical sub-bands, where n′>1, depending on whether disaggregation is needed at the optical node where the insertion/extraction device 20 is located, in which case an optical filtering device capable of removing n′ optical sub-bands such as described above must be used in place of device 23.

If these n′ optical sub-bands are essentially contiguous, it is also possible to use, for the pass-band filtering methods 23, a single pass-band filter having a transfer function with a single removed spectral band of sufficient width to remove the n′ sub-bands to be replaced and, for the band-pass filtering means 25, a single band-pass filter having a transfer function with a single spectral pass-band of sufficient width to extract the n′ optical sub-bands.

In an advantageous embodiment, the width of the spectral band removed by the band-pass filtering means 25 and/or the spectral band removed by the pass-band filtering means 23 is adjustable between a minimum value and a maximum value, for example by means of a management module of the device (not illustrated in FIG. 4A), connected to the band-pass filtering means 25 and to the pass-band filtering means 23.

In a first embodiment, this management module for the device can be integrated into the insertion/extraction device 20. However, in another embodiment, this management module for the device is distanced from this device 20 and can control a plurality of devices 20. In this case, such a management module for the device can notably be responsible for the remote reconfiguration of a transmission system combining WDM and OFDM technologies and integrating a plurality of the devices 20 described in this application.

In a particular embodiment, the optical channel Cᵢ consists of orthogonal frequency-multiplexed optical sub-bands, multiplexed for example using OFDM technology. The principle of the present invention may however be applied to other types of optical channels comprising optical sub-bands of narrow spectral width, multiplexed by means of another technology.

We will now refer to FIG. 4B, which illustrates the steps of a method 230 for replacing at least one optical sub-band SB in an optical signal Cᵢ, as well as the steps of a method 200 for the extraction and replacement of at least one optical sub-band SB in an optical signal Cᵢ according to the present invention.

The replacement method 230 comprises a step 231 of removing the optical sub-band SB from the optical signal Cᵢ by means of the aforementioned optical pass-band filtering method 100 so as to obtain a filtered signal Cᵢ* in which the sub-band SB is removed.

This replacement method further comprises a step 233 of adding a replacement optical sub-band SB′ located spectrally in the optical sub-band SB, to the filtered optical signal Cᵢ*, so as to obtain a modified optical signal Cᵢ′ in which the optical sub-band SB is replaced by the replacement optical sub-band SB′.

As for the extraction and replacement method 200, it begins with a step 201 of duplicating the optical signal Cᵢ in at least two duplicated optical signals Cᵢ(1) and Cᵢ(2).

Following this duplication, the optical sub-band SB is extracted (step 210) from the first duplicated optical signal Cᵢ(1) by means of band-pass filtering means similar to the means 25 described above.

This optical sub-band SB is also replaced (step 230) by a replacement optical sub-band SB′ in the second duplicated optical signal Cᵢ(2) by means of the aforementioned replacement method 230.

These methods allow the replacement and extraction of an optical sub-band of small spectral width, such as a frequency-multiplexed optical sub-band, by using the optical pass-band filtering device proposed in the present invention, and thus allow benefiting from its selectivity and increased compatibility.

We will now refer to FIG. 5A which illustrates an insertion/extraction node using the optical pass-band filtering device 10 according to the present invention. Such an insertion/extraction node is capable of extracting and replacing at least a first optical sub-band SB1 belonging to a first optical channel ch1 contained in an optical signal C itself containing a plurality of wavelength-multiplexed optical channels.

This node 30 comprises duplication means 31 suitable for duplicating the optical signal C ino a first duplicated optical signal 51 and a second duplicated optical signal S2.

The node 30 further comprises extraction means 32 comprising:
a first wavelength-demultiplexing means 33 arranged to extract at least the first optical channel ch1 from the first duplicated optical signal S1;
and at least one optical band-pass filtering means 34 arranged to extract the first optical sub-band SB1 from the first optical channel ch1 demultiplexed by the means 34 so as to output an extracted optical signal comprising the first optical sub-band SB1.

Thus, in the non-limiting example illustrated in FIG. 5A, the first demultiplexing means 33 demultiplexes three (3) optical channels ch1, ch2, and ch3, sent respectively to three (3) optical band-pass filtering means 34, 34′ and 34″ in order to extract the three (3) respective optical sub-bands SB1, SB2 and SB3. The node 30 further comprises:
a second wavelength-demultiplexing means 35 arranged to extract at least the first optical channel ch1 from the second duplicated optical signal S2;
a first optical pass-band filtering device 36 similar to the device 10 described above and arranged to remove the first optical sub-band SB1 in the first extracted optical channel ch1 so as to obtain a first filtered optical channel ch1*;
first coupling means 37 suitable for coupling the first filtered optical channel with an optical signal comprising a first replacement optical sub-band SB1′, so as to output a first modified optical channel ch1 in which the first optical sub-band SB1 is replaced by the first replacement optical sub-band SB1′.

In a particular embodiment where several optical sub-bands are replaced, the second wavelength-demultiplexing means 35 is further arranged to extract a second optical channel ch2, comprising a second optical sub-band SB2, from the second duplicated optical signal S2, and the node comprises:
a second optical pass-band filtering device 36′ similar to the device 10 described above and arranged to remove the second optical sub-band (SB2) in the second extracted optical channel ch2 so as to obtain a second filtered optical channel ch2*;
second coupling means 37′ suitable for coupling the second filtered optical channel with an optical signal comprising a second replacement optical sub-band SB2′ so as to output a second modified optical channel ch2′ in which the second optical sub-band SB2 is replaced by the second replacement optical sub-band SB2′;
wavelength-multiplexing means 38 arranged in order to multiplex at least the first and second modified optical channels so as to obtain a modified optical signal S′ in which the first and second sub-bands have been respectively replaced by the first and second replacement optical sub-bands.

In this way, in the non-limiting example illustrated in FIG. 5A, the second demultiplexing means 35 demultiplexes three optical channels ch1, ch2 and ch3, sent respectively to three optical pass-band filtering means 36, 36′ and 36″ so as to obtain respectively three filtered channels ch1*, ch2* and ch3* in which the three respective optical sub-bands SB1, SB2 and SB3 are removed.

The three replacement optical sub-bands SB1′, SB2′ and SB3′ are added to these three filtered channels by means of three coupling means 37, 37′ and 37″ so as to obtain three modified channels ch1′, ch2′ and ch3′ respectively containing these replacement optical sub-bands SB1′, SB2′ and SB3′. These three modified channels are then multiplexed by the multiplexing means 38 so as to obtain a signal S′ containing these three modified optical channels with their replacement optical sub-bands.

These first and second demultiplexing means 33, 35 as well as these multiplexing means 38 can be WSS-type means in order to allow for spatial switching as well. It is emphasized here that these WSS manage a bandwidth of 50 GHz (typically what an OFDM channel occupies), while the pass-band filters 36, 36′ and 36″ assure the management of OFDM sub-bands which have a typical width of 10 GHz (i.e., 8 pm).

We will now refer to FIG. 5B which illustrates the steps of a method 330 for replacing at least a first optical sub-band SB1 in a first optical channel ch1 of an optical signal S composed of a plurality of wavelength-multiplexed optical channels, as well as the steps of a method 300 for the extraction and replacement of at least a first optical sub-band SB1 in a first optical channel ch1 of an optical signal S according to the present invention.

The replacement method 330 comprises a step 331 of extracting the first optical channel ch1 from the optical signal S.

This replacement method is followed by a step 333 of removing the first optical sub-band from the optical signal by means of the aforementioned optical pass-band filtering method 100 so as to obtain a first filtered channel ch1* from which this optical sub-band SB1 has been removed.

A first replacement optical sub-band SB1′, located spectrally in the first optical sub-band SB1, is thus added (step 335) to the first filtered channel ch1* so as to obtain a modified optical channel ch1′ in which the first optical sub-band SB1 is replaced by the first replacement optical sub-band SB1′.

As for the extraction and replacement method 200, it begins with a step 310 of duplicating the optical signal S into at least two duplicated optical signals 51 and S2.

Next comes a step 320 of extracting the first optical sub-band SB1 from the first duplicated optical signal S1 by means of demultiplexing means and band-pass filtering.

This extraction step notably comprises a sub-step 321 of demultiplexing the duplicated signal S1 so as to extract at least the first optical channel ch1 from this signal, as well as a pass-band filtering step 323 which aims to extract the first optical sub-band SB 1 from this first optical channel ch1.

The method 200 also comprises a step 300 of replacing at least the first optical sub-band SB1, by a first replacement optical sub-band SB1′, in the first optical channel ch1 of the second duplicated optical signal S2, by means of the replacement method 330 described above, so as to obtain a modified optical channel ch1′.

In a particular embodiment where several modified optical channels ch1′, ch2′, etc., are obtained during this replacement step, the method 300 then continues with a multiplexing step 340 to collect the modified optical channels within a same optical signal S′ comprising a plurality of wavelength-multiplexed modified channels, each modified channel having a replacement sub-band.

Of course, the invention is not limited to the example embodiments described and represented above, from which other forms and embodiments can be devised without exceeding the scope of the invention.

1. An optical pass-band filtering device comprising:
a duplicator suitable for duplicating an optical signal on at least a first and second output port;
a first optical filtering unit, connected to the first output port of the duplicator, having a transfer function which decreases between a first pass wavelength and a first cut-off wavelength;
a second optical filtering unit, connected to the second output port of the duplicator, having a transfer function which increases between a second cut-off wavelength and a second pass wavelength, the second cut-off wavelength being higher than the first cut-off wavelength; and
a coupler, connected to the first and second optical filtering units and arranged so as to combine the optical signals filtered by said optical filtering units in order to obtain a filtered optical signal in which the optical band located between the first and second cut-off wavelengths is removed.

2. The filtering device according to claim 1, wherein the first and second filtering units comprise an optical band-pass filter having an essentially rectangular profile in which the cut-off frequency between the first pass wavelength and the first cut-off wavelength, and between the second pass wavelength and the second cut-off wavelength, is at least 30 dB.

3. The filtering device according to claim 1, wherein the spectral difference between the first and second cut-off wavelength is less than or equal to 10 GHz.

4. The filtering device according to claim 1, wherein the spectral difference between the first pass wavelength and the first cut-off wavelength and/or the spectral difference between the second pass wavelength and the second cut-off wavelength is less than or equal to 5 GHz.

5. The optical pass-band filtering device according to claim 1, wherein:
a duplicator is further suitable for duplicating the optical signal on a third output port;
the transfer function of the second optical filtering unit also decreases between a third pass wavelength, higher than the second pass wavelength, and a third cut-off wavelength; and
the device comprises a third optical filtering unit connected to the third output port of the duplicator, having a transfer function which increases between a fourth cut-off wavelength and a fourth pass wavelength, the fourth cut-off wavelength being higher than the third cut-off wavelength; and
the coupler is further connected to the third filtering unit and arranged so as to combine the optical signals filtered by said optical filtering units in order to obtain a filtered optical signal in which the optical band located between the third and fourth cut-off wavelengths is also removed.

6. A method using the optical pass-band filtering device according to claim 1 in order to filter at least one optical sub-band of an optical signal comprising a plurality of frequency-multiplexed optical sub-bands.

7. An insertion/extraction optical device comprising:
a duplicator suitable for duplicating an optical signal into a first duplicated optical signal and a second duplicated optical signal;
an optical band-pass filtering unit arranged to extract a first optical sub-band from the first duplicated optical signal so as to output said first optical sub-band from the device;
the optical pass-band filtering device according to claim 1, arranged to remove a second optical sub-band in the second duplicated optical signal; and
a coupler suitable for coupling the optical signal filtered by the optical pass-band filtering device with an optical signal comprising a replacement optical sub-band located in the spectral range defined by the second optical sub-band, so as to output a modified optical signal in which the second optical sub-band is replaced by the replacement optical sub-band.

8. An optical node for the insertion/extraction of at least a first optical sub-band belonging to a first optical channel contained in an optical signal comprising a plurality of wavelength-multiplexed optical channels, said optical node comprising:
a duplicator suitable for duplicating the optical signal into a first duplicated optical signal and a second duplicated optical signal;
an extractor comprising a first wavelength-demultiplexer arranged to extract at least the first optical channel from the first duplicated optical signal and at least one optical band-pass filter arranged to extract the first optical sub-band from the first extracted optical channel, so as to output an optical signal comprising the sub-first optical band;
a second wavelength-demultiplexer arranged to extract at least the first optical channel from the second duplicated optical signal;
the first optical pass-band filtering device according to claim 1, arranged to remove the first optical sub-band from the first extracted optical channel so as to obtain a first filtered optical channel; and
a first coupler suitable for coupling the first filtered optical channel with an optical signal comprising a first replacement optical sub-band so as to output a first modified optical channel in which the first optical sub-band is replaced by the first replacement optical sub-band.

9. The insertion/extraction node according to claim 8, wherein the second wavelength demultiplexer is further arranged to extract from the second duplicated optical signal a second optical channel comprising a second optical sub-band, and wherein the node comprises:
the second optical pass-band filtering device according to claim 1, arranged to remove the second optical sub-band from the second extracted optical channel so as to obtain a second filtered channel;
a second coupler suitable for coupling the second filtered optical channel with an optical signal comprising a second replacement optical sub-band so as to output a second modified optical channel in which the second optical sub-band is replaced by the second replacement optical sub-band; and
a wavelength-multiplexer arranged to multiplex at least the first and second modified optical channels so as to obtain a modified optical signal in which the first and second sub-bands have been respectively replaced by the first and second replacement optical sub-bands.

10. A method for the optical pass-band filtering of at least a first optical band in an optical signal, said method comprising:
duplicating the optical signal into at least two duplicated optical signals;
filtering the first duplicated optical signal by way of a first optical band-pass filtering unit having a transfer function which decreases between a first pass wavelength and a first cut-off wavelength;
filtering the second duplicated optical signal by way of a second optical band-pass filtering unit having a transfer function which increases between a second cut-off wavelength and a second pass wavelength; and
combining the two filtered optical signals to obtain a filtered optical signal in which the optical band between the first and second cut-off wavelengths is removed.

11. The optical pass-band filtering method according to claim 10, wherein:
the duplication step comprises duplicating the optical signal into three duplicated optical signals;
wherein the transfer function of the second optical pass-band filtering unit also decreases between a third pass wavelength, higher than the second pass wavelength, and a third cut-off wavelength;
the method further comprises:
filtering the third duplicated optical signal by way of a third optical band-pass filtering unit having a transfer function which increases between a fourth cut-off wavelength and a fourth pass wavelength; and
combining the three filtered optical signals during the combination step so as to obtain a filtered optical signal in which the optical band between the third and fourth cut-off wavelengths is also removed.

12. A method for replacing at least a first optical sub-band in an optical signal, said method comprising:
removing the first optical sub-band from the optical signal by way of the optical pass-band filtering method according to claim 10 so as to obtain a filtered signal; and
adding a replacement optical sub-band located spectrally in the first optical sub-band to the filtered optical signal so as to obtain a modified optical signal in which the first optical sub-band is replaced by the replacement optical sub-band.

13. A method for the extraction and replacement of at least a first optical sub-band in an optical signal, said method comprising:
duplicating the optical signal into at least two duplicated optical signals;
extracting the first optical sub-band from the first duplicated optical signal by way of band-pass filtering;
replacing the first optical sub-band by a replacement optical sub-band in the second duplicated optical signal by way of the replacement method according to claim 12.

14. A method for replacing at least a first optical sub-band in a first optical channel of an optical signal composed of a plurality of wavelength-multiplexed optical channels, said method comprising:
extracting of the first optical channel from the optical signal;
removing the first optical sub-band from the optical signal by way of the optical pass-band filtering method according to claim 10, so as to obtain a first filtered channel; and
adding a first replacement optical sub-band located spectrally in the first optical sub-band to the first filtered channel so as to obtain a modified optical channel in which the first optical sub-band is replaced by the first replacement optical sub-band.

15. A method for the extraction and replacement of at least a first optical sub-band in a first optical channel of an optical signal composed of a plurality of wavelength-multiplexed optical channels, said method comprising:
duplicating the optical signal into at least two duplicated optical signals;
extracting the first optical sub-band from the first duplicated optical signal by way of a demultiplexer and a band-pass filter; and
replacing the first optical sub-band by a replacement optical sub-band in the first optical channel of the second duplicated optical signal by way of the replacement method according to claim 14.
